(19) United States
(12) Patent Application Publication
(10) Pub. No.: US 2002/0121420 A1
(43) Pub. Date: Sep. 5, 2002

(54) Fluid fan coupling device

(76) Inventor: Lakshimikantha Medamaranahally, Novi, MI (US)

Correspondence Address: CASELLA & HESPOS, 274 MADISON AVENUE, NEW YORK, NY, 10016

(21) Appl. No.: 09/732,626

(22) Filed: Mar. 5, 2001

(51) Int. Cl. F16D 35/02

(52) U.S. Cl. 192/58.61; 192/58.681; 192/113.21

(57) ABSTRACT

A fan fluid coupling includes a housing that is rotateable mounted to a shaft. A driving disc is rigidly mounted to the shaft and is rotateably disposed within the housing. Oil is disposed in the housing and transmits torque from the driving disc to the housing. The volume of oil adjacent the driving disc is varied directly in accordance with temperature. Thus, more torque is transmitted to the housing when temperature is high and when cooling needs are greatest. At least one outer surface of the housing has cooling fins in the form of short radially aligned plates. The cooling fins are arranged from a central portion on the housing toward the outer edge and are spaced from one another in radially and circumferential directions. The cooling fins reduce the temperature of the oil, and hence avoid heat-related reductions in viscosity.

### BACKGROUND OF THE INVENTION

1. Field of the Invention

The present invention generally relates to a fluid fan coupling device which controls the rotation of a fan for cooling the engine of an automobile and incessantly supplies the engine with the flow of cooling air that corresponds to the outside temperature.

2. Description of the Prior Art

This kind of fan coupling device has heretofore been classified into a temperature sensitive type, a torque-limiting type and an external control type. For example, the temperature sensitive type includes a housing made of a case and a cover which have cooling fins projected from their outer surfaces, and a partition plate having a supply adjustment hole for an oil. The interior of the housing is partitioned by the partition plate into an oil reservoir chamber and a torque transmission chamber in which a driving disc is fitted. A dam is formed on a portion of the inner peripheral wall portion of the housing that is opposed to the outer peripheral wall portion of the driving disc at which the oil is collected and stored during the rotation of the driving disc, and a circulating discharge path is formed to adjoin the dam and extend from the torque transmission chamber to the oil reservoir chamber. A valve member is provided in the interior of the housing, and opens the supply adjustment hole of the partition plate when the outside ambient temperature exceeds a set value or closes the supply adjustment hole of the partition plate when the outside ambient temperature is the set value or below. The temperature sensitive type controls the transmission of torque from its rotating shaft to a driven-side section of the housing by increasing or decreasing the effective contact area of the oil in a torque transmission clearance portion provided between the approximately outward portion of the driving disc and the opposite wall surface of the case and cover.

The torque-limiting type is similar in basic structure to the temperature sensitive type fluid fan coupling device, but is a fan coupling device of the type which does not have a temperature sensitive member or a valve member which opens or closes the supply adjustment hole of the partition plate according to the outside ambient temperature. The shown fluid fan coupling device has the following structure.

The external control type is of a type which a valve member made of a magnetic material is provided for opening or closing the supply adjustment hole of the partition plate, and the valve member having magnetism is controlled by an electromagnet provided at the exterior of the housing. The external control type has a structure which includes, for example, a housing made of a case and a cover which have cooling fins projected from their outer surfaces, and a partition plate having a supply adjustment hole for an oil. The interior of the housing is partitioned by the partition plate into an oil reservoir chamber and a torque transmission chamber in which a driving disc is fitted. A dam is formed on a portion of the inner peripheral wall portion of the housing that is opposed to the outer peripheral wall portion of the driving disc at which the oil is collected and stored during the rotation of the driving disc, and a circulating discharge path is formed to adjoin the dam and extend from the torque transmission chamber to the oil reservoir chamber, and an outlet adjustment path is formed to extend from the oil reservoir chamber to the torque transmission chamber. The transmission of torque from a rotating shaft to a driven-side section of the housing by increasing or decreasing the effective contact area of the oil in a torque transmission clearance portion provided between the fitted driving disc and the opposite surface of the housing. In addition, a pair of electromagnets are provided on the front or rear side of the housing, and a valve member having magnetism to open or close the outlet adjustment path is disposed in opposition to one of the pair of the electromagnets, while a sub-valve member having magnetism to open or close the circulating discharging path is disposed in opposition to the other.

The structure of the cooling fins in the fan coupling device of each of the temperature sensitive type, the torque-limiting type and the external control type is such that plates 35a or 36a of the type shown in FIG. 6 or 7 are arranged along radial straight lines from the central portion of the cover 3 or the case 2 toward the outer peripheral portion of the same, and are projected outward from the cover 3 or the case 2.

However, such a related-art fan coupling device using the driving disc has a number of problems. Since the flow of the oil out of the torque transmission clearance portion formed between the inner peripheral portion of the housing and the outer peripheral portion of the driving disc during rotating operation is caused by the dam and the centrifugal force of the driving disc during the rotation thereof, the oil in the torque transmission clearance portion constantly undergoes shearing and generates heat, and this heat is transmitted to the cover or case. However, in the case of the related art cooling fins which employ plate-shaped cooling fins arranged along straight lines from the approximately central portion of the cover or the case toward the outer peripheral portion of the same, a large number of edge portions are not present and cooling air merely radially flows along the cooling fins, so that a satisfactory edge effect (a boundary-layer separating effect) cannot be obtained and the boundary layer of the cooling air is hardly separated and the radiation of the cooling fins is inferior. Accordingly, the radiation to the outside is insufficient and the viscosity of the oil decreases, so that the related-art fan coupling device cannot perform an optimum control function which follows variations in the outside ambient temperature, and has low reliability and short life.

The present invention has been made in view of the above-described problems, and provides a high-reliability and long-life fluid fan coupling device which allows heat to be efficiently radiated to the outside and restrains as fully as possible a rise in the temperature of an oil due to heating to solve the risk of a decrease in the viscosity of the oil and can, therefore, follow variations in the outside ambient temperature for a long time and perform an optimum control function.

### SUMMARY OF THE INVENTION

Therefore, the gist of the present invention resides in a temperature sensitive type fluid fan coupling device which includes: a rotating shaft to which a driving disc is fixed at its extending end; a housing supported on the rotating shaft by a bearing, the housing being made of a case and a cover which have cooling fins projected from their outer peripheries; a partition plate having a supply adjustment hole for an oil, the interior of the housing being partitioned by the partition plate into an oil reservoir chamber and a torque transmission chamber in which the driving disc is fitted; a dam which is provided on a portion of the inner peripheral wall portion of the housing that is opposed to the outer peripheral wall portion of the driving disc at which the oil is collected and stored during the rotation of the driving disc; and a circulating discharge path which adjoins the dam and extends from the torque transmission chamber to the oil reservoir chamber. The cooling fins are made of radial short plates which are projected in radial form from at least one side surface of the housing in the state of being arranged from the central side of the housing toward the outer edge portion of the same and being spaced apart from one another at desired intervals in radial and circumferential directions of the housing, and the radial short plates are shifted in phase in the circumferential directions in an alternate manner. In addition, the cooling fins are arranged in such a manner that each circumferential row of fins is out of phase with a radially adjacent circumferential row of fins with the circumferential rows of fins being arranged in radially consecutive form.

In the present invention, the cooling fins provided on the housing are made of radial short plates each having edges and are projected in radial form in the state of being spaced apart from one another at desired intervals in the radial and circumferential directions of the housing, and the radial short plates are shifted in phase in the circumferential directions in an alternate manner. The reason for this is that the rotating motion of the cooling fins causes turbulences in the flow of external cooling air by the cooling fins and its boundary layer is separated by the contact (edge effect) between this turbulent cooling air and each of the edge portions of the cooling fins to enhance heat transfer between the cooling air and the cooling fins, whereby it is possible to improve the radiation effect of the cooling fins and restrain far more fully a rise in the temperature of the torque-transmitting oil charged in the interior of the housing. In the case where the cooling fins are arranged in such a manner that each circumferential row of fins is out of phase with a radially adjacent circumferential row of fins with the circumferential rows of fins being arranged in radially consecutive form, it is possible to improve the radiation effect of the cooling fins far more fully.

The length of each of the radial short fins is not limited to a specific value, but needs at least approximately three times as large as the average thickness of the fins.

According to the present invention, the cooling fins are made of radial short plates each having edges and are arranged in radial form in the state of being arranged from an approximately central portion of the housing toward the outer edge portion of the same and being shifted in phase in the circumferential directions in an alternate manner. Since a rise in the temperature of the torque-transmitting oil charged in the interior of the housing can be restrained as fully as possible by the edge effect of the cooling fins, it is possible to solve the risk of a decrease in the viscosity of the oil, whereby it is possible to provide a high-reliability and long-life fan coupling device which can follow variations in the outside ambient temperature for a long time and perform an optimum control function.

### BRIEF DESCRIPTION OF THE DRAWINGS

The invention will become more readily appreciated and understood from the following detailed description of preferred embodiments of the invention when taken in conjunction with the accompanying drawings, in which:

FIG. 1 is a cross-sectional view of one embodiment of the fluid fan coupling device according to the present invention;

FIG. 2 is a front view showing cooling fins provided on a cover in the fan coupling device shown in FIG. 1;

FIG. 3 is a partial perspective view showing on an enlarged scale the cooling fins;

FIG. 4 is a cross-sectional view of another embodiment of the fluid fan coupling device according to the present invention;

FIG. 5 is a vertical cross-sectional view showing of another embodiment of the fluid fan coupling device according to the present invention;

FIG. 6 is a partial perspective view showing on an enlarged scale one example of a related art cooling fin; and

FIG. 7 is a partial perspective view showing on an enlarged scale another example of a related art cooling fin.

### DETAILED DESCRIPTION OF PREFERRED EMBODIMENTS

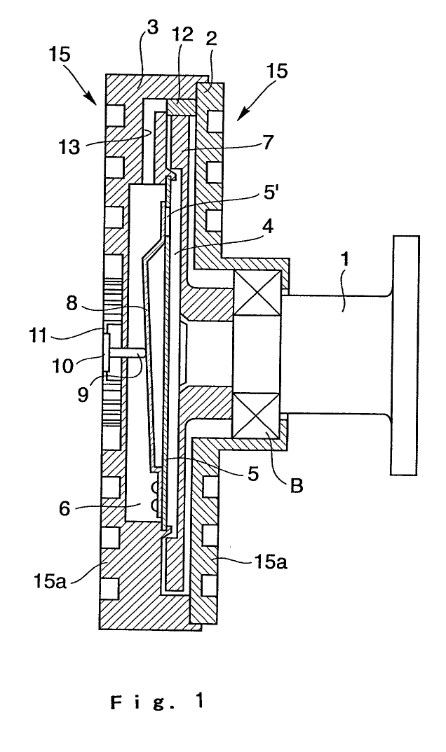

The fluid fan coupling device according to the present invention, which is shown in FIG. 1, is of a temperature sensitive type. Reference numeral 1 denotes a rotating shaft to which a driving disc is fixed at its extending end, and a housing which is made of a case 2 and a cover 3 having a cooling fan (not shown) secured to its outer periphery is supported on the rotating shaft 1 by a bearing B. Reference numeral 5 denotes a partition plate which partitions the interior of the housing into an oil reservoir chamber 6 and a torque transmission chamber 4 in which the driving disc 7 is fitted, and a supply adjustment hole 5′ which adjusts an oil to be supplied from the oil reservoir chamber 6 to the torque transmission chamber 4 is formed in the partition plate 5. The driving disc 7 is disposed in the torque transmission chamber 4, and retains a small clearance for torque transmission between its approximately outward portion and the opposite wall surface of the housing. Reference numeral 8 denotes a valve member which opens or closes the supply adjustment hole 5′. In the oil reservoir chamber 6, the valve member 8 is riveted to the partition plate 5 at one end and is positioned in opposition to the portion of the supply adjustment hole 5′ at the other end. The valve member 8 is disposed in the interior of the oil reservoir chamber 6 in such a manner as to interlock with the deformation of a temperature sensitive member 10 due to a variation in the outside ambient temperature via a connecting rod 9, the temperature sensitive member 10 being made of a plate-shaped bimetal which has both ends engaged with a support fitting 11 secured to the front of the cover 3. Reference numeral 12 denotes a dam which is provided on a portion of the inner peripheral wall portion of the housing that is opposed to the outer peripheral wall portion of the driving disc 7 at which an oil is collected and stored during the rotation of the driving disc 7, and a circulating discharge path 13 which extends from the torque transmission chamber 4 to the oil reservoir chamber 6 is formed in the vicinity of the front side of the dam 12 with respect to the rotating direction of the driving disc 7, and the dam 12 serves a pumping function. Reference numeral 15 generally denotes cooling fins made of multiple radial short plates projected outward from the case 2 and the cover 3 which constitute the housing, and the cooling fins 15 are prepared by forming an aluminum alloy or the like by an appropriate method such as die casting or casting.

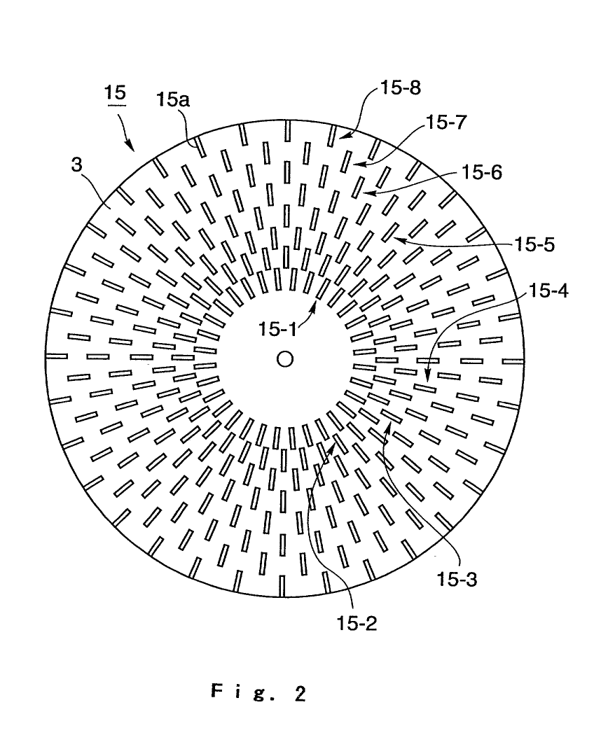

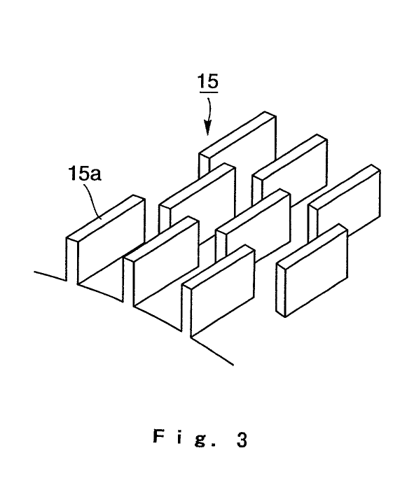

The cooling fins 15 in the temperature sensitive type fluid fan coupling device shown in FIG. 1 are arranged over the case 2 and the cover 3 which constitute the housing, in such a manner that, as shown in FIGS. 2 and 3, short radial fins 15a each having edges are arranged in fin rows which are spaced apart from one another at desired intervals in the circumferential direction of the housing and which are shifted in phase in an alternate manner in the directions from the vicinity of the center of the housing toward the outer edge portion of the same.

Specifically, from among the short radial fins 15a, the ones each having an edge in the vicinity of the center of the housing are arranged to project at desired intervals around circumferences of the housing and constitute first fin rows 15-1, while the others each having an edge similarly to the first fin rows 15-1 on the outside of the first fin rows 15-1 are arranged to project at desired intervals around circumferences of the housing and constitute second fin rows 15-2, and the first fin rows 15-1 and the second fin rows 15-2 are arranged out of phase with each other. In this case, the second fin rows 15-2 are projected so that their inner ends are located on a concentric circle formed by the outer ends of the first fin rows 15-1. In this case, the second fin rows 15-2 and the first fin rows 15-1 may be radially spaced apart to a small extent. Similar third fin rows 15-3 are projected in phase with the first fin rows 15-1 on the outside of the second fin rows 15-2 so that the inner ends of the third fin rows 15-3 are located on a concentric circle formed by the outer ends of the second fin rows 15-2. In this manner, fourth fin rows 15-4 to eighth fin rows 15-8 are arranged alternately out of phase with one another up to the outer edge portion of the housing.

Incidentally, the short radial fins 15a each having edges may be of the same length, or may also differ in length for each of the fin rows.

In the case of the temperature sensitive type fluid fan coupling device including the cooling fins 15 having the above-described structure, during the rotation of the cooling fins 15, turbulences are caused in the flow of external cooling air by the action of the short radial fins 15a each of which has edges and which are arranged in radial form alternately out of phase with one another over the entire surface of the housing, and these turbulences in the flow of external cooling air improve the efficiency of heat transfer from the cooling fins 15 to the external cooling air, whereby the radiation effect of the cooling fins 15 is enhanced to solve the risk of a decrease in the viscosity of the torque-transmitting oil charged in the interior of the housing. Accordingly, the temperature sensitive type fluid fan coupling device can follow variations in the outside ambient temperature for a long time and perform an optimum control function.

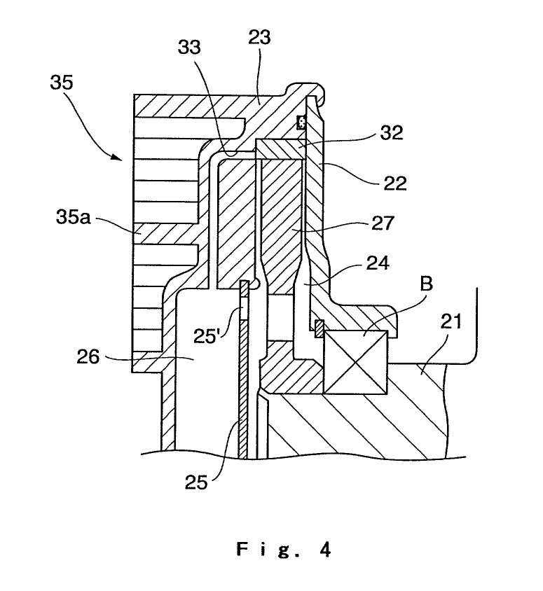

The fluid fan coupling device shown in FIG. 4 is of a torque limiting type which is similar in basic structure to the above-described temperature sensitive type fluid fan coupling device, but is a fan coupling device of the type which does not have a valve member which opens or closes the partition plate according to the outside ambient temperature. The shown fluid fan coupling device has the following structure. A housing which is made of a case 22 and a cover 23 having a cooling fan (not shown) secured to its outer periphery is supported via the bearing B on a rotating shaft 21 to which a driving disc 27 is fixed, and the interior of the housing is partitioned into an oil reservoir chamber 26 and a torque transmission chamber 24 in which the driving disc 27 is fitted, and a supply hole 25′ through which to supply an oil from the oil reservoir chamber 26 to the torque transmission chamber 24 is formed in the partition plate 25. The driving disc 27 is disposed in the torque transmission chamber 24, and retains a small clearance for torque transmission between its approximately outward portion and the opposite wall surface of the housing. Reference numeral 32 denotes a dam which is provided on a portion of the inner peripheral wall portion of the housing that is opposed to the outer peripheral wall portion of the driving disc 27 at which an oil is collected and stored during the rotation of the driving disc 27, and a circulating discharge path 33 which extends from the torque transmission chamber 24 to the oil reservoir chamber 26 is formed in the vicinity of the front side of the dam 33 with respect to the rotating direction of the driving disc 7, and the dam 32 serves a pumping function. Reference numeral 35 generally denotes cooling fins which, similarly to the above-described ones, are made of multiple short radiation fins 35a projected from the case 22 and the cover 23 which constitute the housing, and the cooling fins 35 are prepared mainly by forming an aluminum alloy or the like by an appropriate method such as die casting or casting.

In the case of the torque limiting type of fluid fan coupling device as well, during the rotation of the housing provided with the cooling fins 35, a circular flow is caused in external cooling air, and the collisions between the circular flow and the multiple cooling fins 35 having discontinuous edges improve the efficiency of heat transfer from the cooling fins 35 to the external cooling air, whereby the radiation effect of the cooling fins 35 is enhanced to prevent a rise in the temperature of the torque-transmitting oil charged in the interior of the housing, thereby solving risks such as the degradation of the oil, a decrease in the viscosity of the oil and the degradation of the bearing. Accordingly, the torque-limiting type fluid fan coupling device can follow variations in the outside ambient temperature for a long time and perform an optimum control function. It goes without saying that the present invention can also be applied to a torque-limiting type of coupling having a far simpler structure in which the partition plate 25, the dam 32 and the circulating discharge path 33 are omitted.

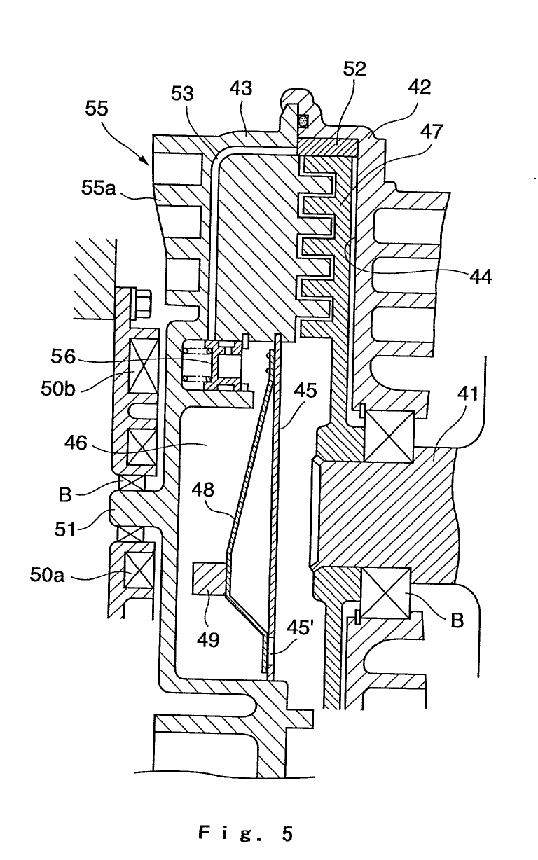

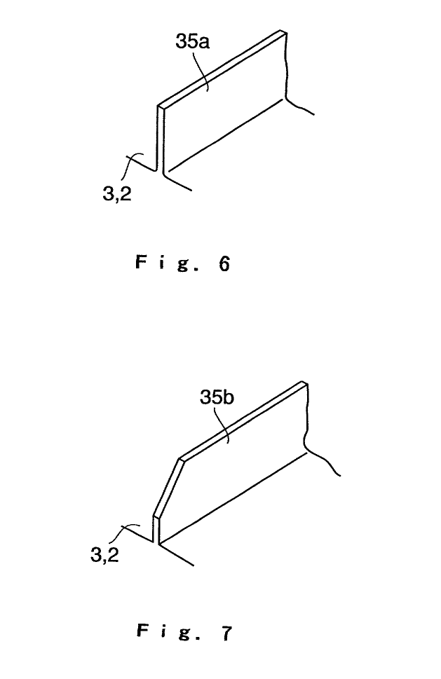

The fluid fan coupling device shown in FIG. 5 is of an external control type which is similar in structure to the above-described temperature sensitive type fluid fan coupling device, but is of a type which a valve member made of a magnetic material is provided for opening or closing a supply adjustment hole formed in a partition plate which partitions a housing into an oil reservoir chamber and a torque transmission chamber in which a driving disc is fitted, and the valve member having magnetism is controlled by an electromagnet provided at the exterior of the housing. The shown fluid fan coupling device has the following structure. A housing which is made of a case 42 and a cover 43 having a cooling fan (not shown) secured to its outer periphery is supported via the bearing B on a rotating shaft 41 to which a driving disc 47 is fixed, and the interior of the housing is partitioned into an oil reservoir chamber 46 and a torque transmission chamber 44 in which the driving disc 47 is fitted, and a supply hole 45′ through which to supply an oil from the oil reservoir chamber 46 to the torque transmission chamber 44 is formed in the partition plate 45. The driving disc 47 is disposed in the torque transmission chamber 44, and retains a small clearance for torque transmission between its approximately outward portion and the opposite wall surface of the housing. Reference numeral 52 denotes a dam which is provided on a portion of the inner peripheral wall portion of the housing that is opposed to the outer peripheral wall portion of the driving disc 47 at which an oil is collected and stored during the rotation of the driving disc 47, and a circulating discharge path 53 which extends from the torque transmission chamber 44 to the oil reservoir chamber 46 is formed in the vicinity of the front side of the dam 52 with respect to the rotating direction of the driving disc 47, and the dam 52 serves a pumping function. In the oil reservoir chamber 46, the valve member 48 is secured to the partition plate 45 at one end and is positioned at the portion of the supply adjustment hole 45′ at the other end, and a magnetic member 49 is secured to an intermediate portion of the valve member 48. The valve member 48 is arranged to open or close the supply adjustment hole 45′ by following the presence or absence of an exciting current in a concentric-ring-shaped electromagnet 50a which is provided at a position opposite to the magnetic member 49 on the front side of the housing. In addition, a slide valve which serves as a sub-valve member 56 made of a magnetic material is secured to the outlet of the circulating discharge path 53 (the opening located on the side of the oil reservoir chamber 46), and the slide valve is arranged to open or close the outlet of the circulating discharge path 53 by the action of a ring-shaped electromagnet 50b which is provided on the front side of the housing in opposition to the slide valve. The central portion of the pair of ring-shaped electromagnets 50a and 50b is secured via the bearing B to a support shaft 51 which is provided at the outside center of the housing, and the peripheral portion of the pair of ring-shaped electromagnets 50a and 50b is fixed to a portion of a vehicle or the like. Reference numeral 55 generally denotes cooling fins which, similarly to the above-described ones, are made of multiple short radiation fins 55a projected from the case 42 and the cover 43 which constitute the housing, and the cooling fins 35 are prepared mainly by forming an aluminum alloy or the like by an appropriate method such as die casting or casting.

In the case of the external control type of fluid fan coupling device as well, during the rotation of the housing provided with the cooling fins 55 having edges, a circular flow is caused in external cooling air, and the collisions between the circular flow and the multiple cooling fins 55 having discontinuous edges improve the efficiency of heat transfer from the cooling fins 55 to the external cooling air, whereby the radiation effect of the cooling fins 55 is enhanced to prevent a rise in the temperature of the torque-transmitting oil charged in the interior of the housing, thereby solving risks such as the degradation of the oil, a decrease in the viscosity of the oil and the degradation of the bearing. Accordingly, it is possible to provide a fluid fan coupling device which can follow variations in the outside ambient temperature for a long time and perform an optimum control function and which has high reliability and long life. Incidentally, it is possible to adopt any type of external control.

In the shown embodiments, the cooling fins 15; 35; 55 are provided on both of the case 2; 22; 42 and the cover 3; 23; 43, but in the present invention, it is essential to project such cooling fins from either side surface of the housing, i.e., either of the case and the cover, and if the cooling fins are projected from both of the case and the cover, the radiation effect is improved to a further extent.

As is apparent from the foregoing description, according to the present invention, short radial fins each having edges are arranged in fin rows which are spaced apart from one another at desired intervals in the circumferential direction of a housing and are shifted in phase in an alternate manner in the directions from the vicinity of the center of the housing toward the outer edge portion of the same, and during the rotation of such cooling fins, turbulences are caused in the flow of external cooling air which flows over the entire surface of the housing as well as in contact with the surface portions of the cooling fins, and these turbulences in the flow of external cooling air improve the efficiency of heat transfer from the cooling fins to the external cooling air, whereby it is possible to provide a fan coupling device capable of serving a large number of superior advantages.

For example, since the amount of radiation of the cooling fins is increased to solve the risk of a decrease in the viscosity of a torque-transmitting oil charged in the interior of the housing, it is possible to provide a fan coupling device capable of following variations in the outside ambient temperature for a long time and performing an optimum control function, whereby it is possible to increase the lifetime and reliability of the fan coupling device. In addition, it is possible to decrease the size and weight of the fan coupling device due to an improvement in the radiation characteristics thereof, and it is also possible to reduce the cost of the fluid fan coupling device.

What is claimed is:

1. A fluid fan coupling device comprising:
a rotating shaft to which a driving disc is fixed at its extending end;
a housing supported on the rotating shaft by a bearing, the housing being made of a case and a cover which have cooling fins projected from their outer peripheries;
a partition plate having a supply adjustment hole for an oil, the interior of the housing being partitioned by the partition plate into an oil reservoir chamber and a torque transmission chamber in which the driving disc is fitted;
a dam which is provided on a portion of the inner peripheral wall portion of the housing that is opposed to the outer peripheral wall portion of the driving disc at which the oil is collected and stored during the rotation of the driving disc; and
a circulating discharge path which adjoins the dam and extends from the torque transmission chamber to the oil reservoir chamber,
the cooling fins being made of radial short plates which are projected in radial form from at least one side surface of the housing in the state of being arranged from the central side of the housing toward the outer edge portion of the same and being spaced apart from one another at desired intervals in radial and circumferential directions of the housing, the radial short plates being shifted in phase in an alternate manner.

2. A fluid fan coupling device according to claim 1, wherein the cooling fins are arranged in such a manner that each circumferential row of fins is out of phase with a radially adjacent circumferential row of fins with the circumferential rows of fins being arranged in radially consecutive form.
